(19) United States
(12) Patent Application Publication
(10) Pub. No.: US 2026/0249307 A1
(43) Pub. Date: Aug. 27, 2026

(54) CENTRIFUGE

(71) Applicant: GEA WESTFALIA SEPARATOR GROUP GMBH, Oelde (DE)

(72) Inventors: Eduard BRAK, Oelde (DE); Julian STEINER, Oelde (DE); Jürgen MACKEL, Oelde (DE); Tim HUNDERTMARK, Gütersloh (DE)

(21) Appl. No.: 19/162,682

(22) PCT Filed: Mar. 4, 2024
(86) PCT No.: PCT/EP2024/055622

§ 371 Date: Sep. 5, 2025

(30) Foreign Application Priority Data
Mar. 6, 2023 (DE) 10 2023 105 408.2

(51) Int. Cl. B04B 1/08; B04B 9/02; B04B 9/08; B04B 9/12

(52) U.S. Cl. CPC B04B 1/08; B04B 9/02; B04B 9/08; B04B 9/12

(57) ABSTRACT

A centrifuge includes a drum with a vertical axis of rotation, a drive spindle mounted by a neck bearing and a foot bearing in a rotatable manner in or on a machine frame, and a drive motor. The neck bearing is axially displaceable and radially supported. A spring is arranged centrally below the foot bearing, the spring supporting the unit of the drum, drive spindle, neck bearing, and foot bearing in a sprung manner and deflectable in an axially limited manner with respect to the machine frame. The axially limited deflectability of the working spindle is achieved in that the foot bearing is mounted, by way of its outer ring, in a sleeve which is arranged on the spring.

### BACKGROUND AND SUMMARY OF THE INVENTION

Exemplary embodiments of the present invention relate to a centrifuge.

On seagoing vessels, centrifuges—in particular separators—are used for various tasks. In the case of ship propulsion systems with heavy oil diesel engines, for example, heavy oil processing is often carried out with the aid of separators. Such separators must be able to withstand high shock loads (up to 100 g), as can occur on naval vessels in particular. To be able to fulfill such requirements, the machine frames of the separators have been mounted according to a prior art on shock absorbers, which are intended to absorb the shock energy that occurs.

Such shock absorbers are usually designed in such a way that they have a “long” spring travel and high damping. The disadvantage of this is that it can lead to undesirable rocking movements of the separator or the system in rough seas.

A centrifuge with spring-mounted machine feet is known from DE 10 2014 116 404 A1.

DE 10 2012 110 846 A1 also discloses a centrifuge designed for use on ships, among other things, in which the drive spindle is rotatably mounted in a drive housing with a neck bearing and a foot bearing. The neck bearing is supported radially in a bearing housing via at least one elastic element, which is attached to the drive housing. The foot bearing is arranged as an axial fixed bearing via its outer ring in the drive housing in an articulated, cardanically inclinable manner by means of a joint element and/or is itself designed in the manner of a joint bearing, so that the drive spindle can follow precessional movements of the centrifuge drum during operation.

Furthermore, a centrifugal machine with a vertical rotor is known from DE 2 324 488 A, wherein the vertical rotor is spring-loaded by at least three elastic radial elements, at least three elastic axial elements, and an elastic coupling in such a way that vibrations of the rotor can be cushioned against the rigidly mounted frame. This involves a great deal of effort. However, radial or axial deflections of the rotor from its center position are virtually unlimited in their path. The cause of the vibrations to be damped or a shock load in this type lies in the centrifuge itself and is caused, for example, by imbalances in the drum or fluid vibrations. The damping of vibrations or shock loads acting on the centrifuge from outside is not the object of the technical teaching described here.

Based on the prior art, exemplary embodiments of the invention are directed to simple means to reduce the negative influences of a shock-like load acting on a centrifuge from outside.

Accordingly, a centrifuge, which is designed as a separator, is provided in a centrifugal field to separate a product to be processed into a solid phase and at least one liquid phase, wherein the centrifuge is designed, in particular, for use under shock-like load on a ship and has at least the following:
a centrifuge drum with a vertical axis of rotation in which a disk stack is arranged,
a drive spindle of the centrifuge drum, which is rotatably mounted in and/or on a machine frame by means of a neck bearing and a foot bearing,
a drive motor designed to drive the drive spindle,
the neck bearing is axially displaceable and radially supported,
a spring is arranged centrally under the foot bearing of the drive spindle, which spring supports the unit consisting of the rotating centrifuge drum, the drive spindle, the neck bearing and the foot bearing in an axially limited deflectable resilient manner with respect to an abutment, which is in particular the machine frame, and
the limited axial deflectability of the working spindle is realized by mounting the foot bearing with its outer ring in a sleeve arranged on the spring.

In this way, the shock on the drive spindle together with the drum and the bearing—i.e., in principle the rotor—is absorbed very well in a simple manner due to its axial displaceability in combination with its spring suspension.

According to an advantageous embodiment variant of the invention, the neck bearing is designed as a floating bearing, which is axially displaceable via its inner ring and can be radially resiliently supported in a housing via its outer ring. In this way, vibrations acting in a radial direction on the rotating system of the centrifuge can also be damped easily and advantageously in this area in terms of design and production technology.

According to a further, particularly preferred embodiment option of the invention, the sleeve has a collar (in the manner of a flange) projecting radially outwards on its upper axial side, by means of which a downward axial movement of the sleeve is limited. This simply limits the path in the axial direction that the sleeve can cover.

Furthermore, according to a further, particularly preferred embodiment variant of the invention, a maximum possible path of the sleeve during a downward movement is dimensioned in such a way that the spring is not compressed to a block. This allows the spring to achieve a long service life.

It is also advantageous if, according to one design, the spring is designed as a coil spring or has one or more disk spring(s). This results in a spring that is small in size, simple in design and yet safe in operation.

According to a further, particularly preferred embodiment variant of the invention, the spring is supported on a disk having a centering lug for the spring and the disk is axially fastened to a lower side of a bearing cup, wherein the bearing cup is inserted in a tube-like attachment that is inserted in a lower opening of a machine frame of the centrifuge. This creates an easy-to-mount abutment for the spring that is simple in terms of design and easy to implement in terms of production technology.

Furthermore, according to a further particularly preferred embodiment variant of the invention, the sleeve is designed in such a way that, when the sleeve moves downwards to the maximum possible extent, the centering lug of the spring on the disk dips into the sleeve. As a result, the maximum possible axial downward travel of the drive spindle is clearly limited, namely only by the collar on the sleeve.

According to a further particularly preferred embodiment variant of the invention, the respective machine foot is preferably designed as a rubber-metal part, so that a spring element of the machine foot is preferably made of elastomer. This creates a low-wear, space-saving spring element with additional damping properties.

The rotating system—i.e., the centrifuge drum, the drive spindle, and the bearings-thus forms a first spring-loaded mass, which is inserted into a second spring-loaded mass, namely the entire centrifuge. This means that the machine feet, which are designed as flexible dampers, no longer have to take over the suspension of the entire vibrating system. The spring travel of the machine feet under the machine frame can also be significantly reduced, so that undesirable rocking movements of the separator, caused for example by high swell, are significantly reduced.

In a particularly preferred embodiment variant of the invention, the foot bearing can be tilted in an articulated, cardanic manner relative to the machine frame by means of a ball joint. This allows the drive spindle to follow precessional movements of the centrifuge drum in addition to the suspension and damping of axial and radial accelerations by means of a simple design measure.

It is also advantageous that several path-limiting elements are mounted in an interior space of the hood below and above the centrifuge drum, in each case circumferentially distributed around the centrifuge drum. This makes it easy to limit both the axial and radial deflection of the rotating system as a result of a shock acting on the centrifuge within the centrifuge. The path-limiting elements effectively prevent damage to the bearing of the drive spindle, which permits movement of the drive spindle in the axial and radial directions.

Furthermore, according to a further, particularly preferred embodiment variant of the invention, it may be provided that the respective path-limiting element is designed as a ring or as a ring segment. This results in a path-limiting element that is easy to realize in terms of production technology.

Likewise, according to a further, particularly preferred embodiment option of the invention, it may be provided that the respective path-limiting element is preferably made of a non-ferrous metal, particularly preferably of bronze. In the event of a large axial or radial deflection of the centrifuge drum due to a shock energy introduced into the centrifuge via the machine foundation, the rotating centrifuge drum strikes against these path-limiting elements, which are soft in comparison to the centrifuge drum, wherein part of the energy is absorbed by the machine structure, in particular by the hood and the machine frame.

According to a further, particularly preferred embodiment variant of the invention, it may be provided that an elastic housing, in which the neck bearing is inserted, has a shoulder with which the elastic housing is inserted into a bearing support through which the drive spindle engages, wherein the elastic housing is designed as a rubber-metal part. The elastic housing ensures radial mobility of the drive spindle.

According to a further particularly preferred embodiment variant of the invention, a bearing support, into which the elastic housing is inserted, the elastic housing, and the neck bearing form a pre-assembled and replaceable structural unit. This results in a pre-assembled module which can be easily and quickly mounted in the machine frame of the centrifuge.

Furthermore, according to a further, particularly preferred embodiment variant of the invention, the bearing support and the bearing cup are designed as a one-piece bearing housing, so that the drive spindle with the neck bearing and the elastic housing as well as the foot bearing, the sleeve, the spring, the ball joint, and the disk can be inserted into the machine frame as a pre-assembled unit. This results in a pre-assembled module that can be easily and quickly mounted in the machine frame of the centrifuge.

### BRIEF DESCRIPTION OF THE DRAWING FIGURES

The invention is described in more detail below with reference to the drawing, wherein:

FIG. 1: shows a schematic front view in section of a centrifuge according to the invention;

FIG. 2: a sectional enlargement of a foot bearing of the centrifuge from FIG. 1.

### DETAILED DESCRIPTION

In the following description of the figures, an exemplary embodiment is described. Individual features of this exemplary embodiment can also be combined with exemplary embodiments not shown and are also suitable in each case as advantageous designs of the objects described in individual or several of the main and subclaims.

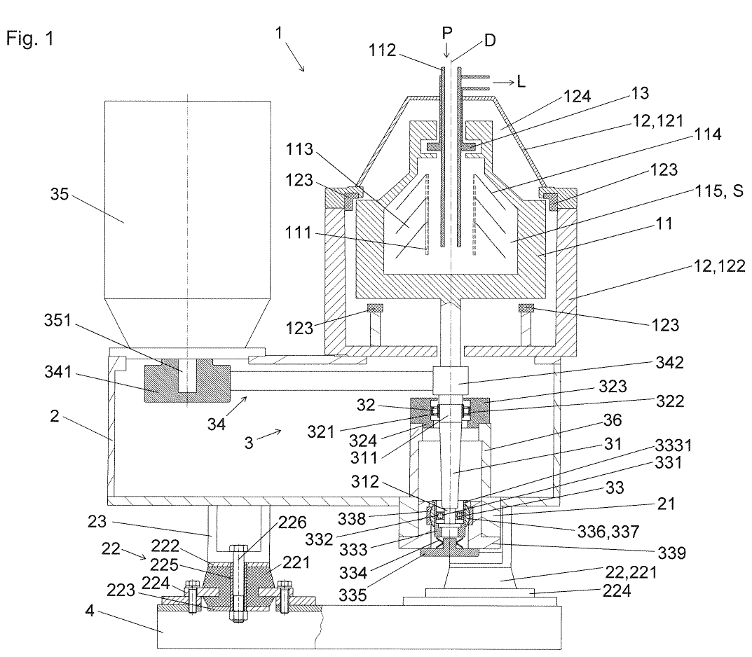

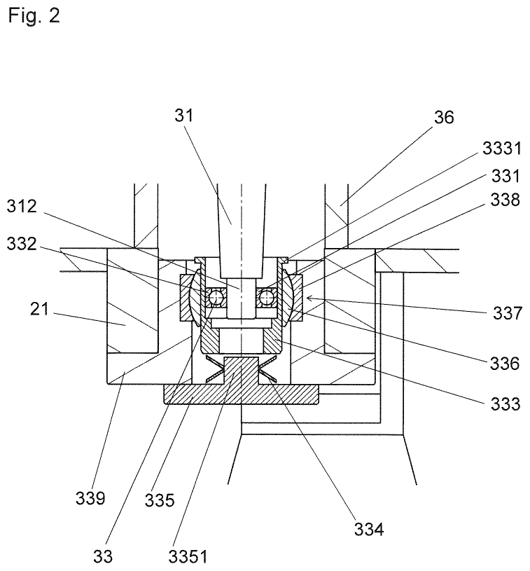

The terms used in the following, such as “top”, “bottom”, “right”, “left”, “horizontal”, “vertical”, “radial”, “axial”, “inner” or “outer”, refer to those of the representation of FIG. 1 or FIG. 2.

FIG. 1 shows a centrifuge 1, wherein the centrifuge 1 is preferably designed as a self-emptying separator. Further elements of the centrifuge 1 are shown here: A machine frame 2, a drive unit 3, and a machine foundation 4 on which the machine frame 2 is arranged. The machine foundation 4 is preferably part of a ship structure or fixed to such a structure.

The centrifuge 1 has a rotatable centrifuge drum 11. The centrifuge drum 11 may have a vertical axis of rotation D. The centrifuge drum 11 is shown here schematically and can also be single and/or double conical (at the bottom and/or top and in particular on the inside, not shown here in every variant).

The centrifuge drum 11 can be designed for batchwise operation as shown. However, it can also be designed for continuous operation, i.e., for continuous, non-batch centrifugal processing of a flowable suspension. The centrifuge can—as shown here—be designed as a clarifier separator, which is intended to clarify a product P (a flowable suspension) to be processed in the centrifugal field or to separate it into a solid phase S and a single liquid phase L. Alternatively or additionally, the centrifuge can also be designed as a separator, which is intended to separate a product P to be processed into two liquid phases L1, L2 and/or into a solid phase S in the centrifugal field.

The centrifuge drum 11 can have an upper drum part and a lower drum part (not shown here). These drum parts can be connected to each other in various ways, for example with a locking ring (also not shown here).

A distributor 111 is formed in the centrifuge drum 11 for feeding product from a product feed pipe 112 into a separation chamber 113. The product P is transferred into the rotating system in the distributor 111. The product feed pipe 112 is fed into the centrifuge drum 11 from above through a hood 12, which is stationary during operation of the centrifuge 1, or from the end of the centrifuge drum 11 opposite a drive spindle 31.

The hood 12 surrounds the centrifuge drum 11. It can be arranged on the machine frame 2 and supported thereon. In this example, the hood 12 is divided into an upper conical hood section 121 and a lower cylindrical hood section 122, which can be designed as a solids catcher.

The actual centrifugal separation of the product P into different phases takes place in the separation chamber 113. The separation chamber 113 preferably has a separating means such as a disk stack 114 consisting of separating disks. It also has a solids collecting chamber 115 radially on the outside, in which the solid phase S separated from the suspension or the flowable product P collects during the separation and/or clarification process.

Furthermore, the centrifuge 1 here has a single liquid discharge 13, via which a liquid phase L can be discharged from the centrifuge drum 11. The liquid discharge 13 is designed here as a so-called paring disk, which operates as a centripetal pump. The liquid discharge 13 can also be realized in another way. Several liquid phases can also be discharged, in which case the centrifuge drum 11 must be provided with a corresponding additional discharge system (e.g., with an additional paring disk and a separating plate for feeding an additional liquid phase to this paring disk, both not shown).

An emptying system (not shown here), which can be of fluid-actuated design, can be provided for discharging the solid phase S from the solids collecting chamber 115 of the centrifuge drum 11.

A drive spindle 31 for rotating the centrifuge drum 1 is rotatably mounted in the machine frame 2 in an upper neck bearing 32 and a lower foot bearing 33. The drive spindle 31 carries the centrifuge drum 11, which is mounted or integrally formed on a free end of the drive spindle 31. The drive spindle 31 passes through the hood 12. The drive spindle 31 is rotated here by means of a wrap-around gear 34 and a drive motor 35. The drive motor 35 is attached to the machine frame 2. Alternatively, other drive variants are also conceivable, such as a direct drive of the centrifuge drum 11 by the drive motor 35. However, the drive shown here is preferred.

The wrap-around gear 34 is preferably designed as a belt transmission and thus has a first belt pulley 341, which is mounted non-rotatably on a drive shaft 351 of the drive motor 35. The belt transmission also has a second belt pulley 342, which is non-rotatably mounted on the drive spindle 31 in the axial direction between the neck bearing 32 and the hood 12.

The neck bearing 32 is preferably designed as a roller bearing, particularly preferably—as shown here—as a cylindrical roller bearing, which can have an inner ring 321 and an outer ring 322. If necessary, the neck bearing 32 can also be arranged in pairs if the forces to be absorbed require this. The neck bearing 32 is mounted here with its inner ring 321 on a cylindrical shoulder 311 of the drive spindle 31. The neck bearing 32 can be inserted into an elastic housing 323 and guided in the housing 323 so as to be vertically displaceable and radially resiliently supported. The neck bearing 32 can be designed as a floating bearing, so that the inner ring 321 of the neck bearing 32, which is fixedly connected to the drive spindle 31, can move axially relative to the outer ring 322. The neck bearing 32 can also be designed differently, for example as a magnetic bearing.

The elastic housing 323 has a shoulder 324, with which the elastic housing 323 is inserted into a bearing support 36, through which the drive spindle 31 passes. The neck bearing 32 is thus axially supported on the bearing support 36 via the elastic housing 323. Preferably, the elastic housing 323 is fixed to the bearing support, for example pressed in and thus secured axially and against rotation. The bearing support 36 with the elastic housing 323 and the neck bearing 32 is inserted into the machine frame 2.

The elastic housing 323 can be designed as a rubber-metal part and thus be of a simple design, for example consisting of two metallic sleeves or disks that are connected to each other by means of a ring made of elastomer material. More than two metallic sleeves or disks may also be provided. The elastic housing 323 can also be designed differently, for example coil springs or springs of a different design are also possible as resilient elements.

Preferably and advantageously, the bearing support 36, the elastic housing 323, and the neck bearing 32 form a pre-assembled and replaceable structural unit.

The foot bearing 33—see also FIG. 2—is also preferably designed as a rolling bearing and can—as shown here—be designed as a deep groove ball bearing or as a cylindrical roller bearing, which has an inner ring 331 and an outer ring 332. If necessary, the foot bearing 33 can also be arranged in pairs if the forces to be absorbed require this. The foot bearing 33 is mounted here with its inner ring 331 on a cylindrical shoulder 312 of the drive spindle 31. The foot bearing 33 can also be designed differently, for example as a magnetic bearing.

FIG. 1 and FIG. 2 show that the rotating system, i.e., the unit consisting of the rotating centrifuge drum 11, the drive spindle 31, the neck bearing 32, and the foot bearing 33, is supported axially resiliently relative to the machine frame 2 by a spring 334 arranged centrally under the foot bearing 33 of the axially movable drive spindle 31. The axial mobility of the work spindle 31 is realized by the foot bearing 33 being mounted with its outer ring 332 in a sleeve 333, which is arranged on the spring 334. For the purposes of the invention, sleeve 333 is understood to be a tubular, elongated, fixed casing.

The spring 334 can be designed as a coil spring or—as shown here—have one or more disk spring(s) or be designed by another suitable elastic element. The spring 334 is supported here on a disk 335, which may have a centering lug 3351 for the spring 334. The outer ring 332 of the foot bearing 33 is thus radially supported in the sleeve 333.

The sleeve 333 is in turn inserted axially displaceably in a bore of an inner sleeve 336 of a ball joint 337. The ball joint 337 is composed of the convex, spherical ring-like inner sleeve 336 and a concave outer sleeve 338 form-fit to the convex inner sleeve 336. Such ball joints 337 are also known as ball joint bearings. The outer sleeve 338 of the ball joint 337 is inserted into a bearing cup 339 and can be fixed in the axial direction by a housing shoulder of the bearing cup 339 and by a further securing element.

On its upper axial side, the sleeve 333 has a flange-like collar 3331 projecting radially outwards, by means of which an axial downward movement of the sleeve 333 is limited, since the collar 3331 strikes against an axial upper side of the inner sleeve 336 of the ball joint 337 when the sleeve 333 moves downwards by a correspondingly large distance. The maximum possible travel is dimensioned such that the spring 334 is not compressed “on block”. The sleeve 333 is also designed in such a way that the centering lug 3351 of the spring 334 on the disk 335 plunges into the sleeve 333.

The ball joint 337 allows the foot bearing 33 to tilt in an articulated, cardanic manner relative to the machine frame 2. The center of the ball of the ball joint 337 lies—if there is no axial deflection during operation of the centrifuge 1—essentially in the center of the foot bearing 33. The disk 335 is axially fastened to a lower side of the bearing cup 339. It is also conceivable that the foot bearing 33 itself is designed like a spherical plain bearing.

The bearing cup 339 is inserted here in a tubular lug 21, which is inserted in a lower opening of the machine frame 2. The bearing support 36 is placed on the upper side of the tubular lug 21 in the axial direction. Alternatively, the bearing support 36 and the bearing cup 339 can also be designed as a one-piece bearing housing, so that the drive spindle 31 with the neck bearing 32 and the elastic housing 323 as well as the foot bearing 33, the sleeve 333, the spring 334, the ball joint 337, and the disk 335 can be inserted into the machine frame 2 as a pre-assembled unit.

The axial mobility of the drive spindle 31 is achieved by the sliding sleeve 333 in the lower foot bearing 33 and the upper neck bearing 32 provided as a floating bearing.

The elastic housing 323, in which the neck bearing 32 is inserted, enables radial movement of the drive spindle 31. The elastic elements are arranged between the machine frame 2 and the outer ring 322 of the neck bearing 32. The pivot point or pendulum base is located in the foot bearing 33.

For its part, the machine frame 2 is connected to the machine foundation 4 via several machine feet 22 or is placed on this. The machine feet 22 are preferably designed as flexible dampers or shock absorbers, wherein at least one spring element 221 of the machine foot 22 can be provided, which can preferably be made of elastomer.

Here, the respective machine foot 22 is preferably designed as a rubber-metal part. The machine foot 22 can have a round cross-section. The respective machine foot 22 here has a first plate 222 on its upper side and a second plate 223 on its underside. The two plates 222, 223 are preferably made of metal, particularly preferably of steel. A ring 224 can be arranged between the two plates 222, 223.

One inner side of the ring 224 is radially immersed in the spring element 221, while an outer side of the ring 224 is located outside the spring element 221. On the outer side of the ring 224, circumferentially distributed holes are arranged, via which the respective machine foot 22 can be fastened to the machine foundation 4, preferably by screwing. The respective machine foot 22 can also have a centric sleeve 225. The sleeve 225 is penetrated here by a screw 226, with which the respective machine foot 22 is fastened in each case to a support 23 of the machine frame 2. The two plates 222, 223, the ring 224 and the sleeve 225 are preferably vulcanized together with the spring element 221.

In this way, a shock-like acceleration introduced via the machine foundation 4 can be partially absorbed by machine feet 22 and thus passed on to the rotating system of the centrifuge 1—i.e., bearings 32, 33, drive spindle 31, and centrifuge drum 11—in a damped manner.

As described, the rotating system of the centrifuge 1 is elastically mounted in the axial and radial directions. As a result, a shock-like acceleration indirectly introduced into the rotating system by the machine foundation 4 is well damped.

Both the axial and radial deflection of the rotating system as a result of a shock acting on the centrifuge 1 is limited within the centrifuge 1. For this purpose, according to a further development and also a further variant, a plurality of path-limiting elements 123, which are preferably made of a non-ferrous metal, such as bronze, can optionally have been mounted in an interior 124 of the hood 12 below and above the centrifuge drum 11, in each case circumferentially distributed around the centrifuge drum 11. The respective path-limiting element 123 can be designed as a ring or as a ring segment. The respective path-limiting element 123 can also be made of a material other than non-ferrous metal, for example plastic.

In the event of large axial or radial deflection of the centrifuge drum 11 due to a shock energy introduced into the centrifuge 1 via the machine foundation 4, the rotating centrifuge drum 11 can strike against these path-limiting elements 123, which are soft compared to the centrifuge drum 11, wherein part of the energy is then absorbed by the machine structure, in particular by the hood 12 and the machine frame 2. The path-limiting elements 123 can often prevent the bearing of the drive spindle 31, which allows the drive spindle 31 to move in an axial and radial direction, from being damaged.

The rotating centrifuge drum 11 together with the drive spindle 31 and the bearing 32, 33 is therefore resiliently supported in the machine frame 2 on the one hand, and the machine frame 2 is resiliently supported on the machine foundation 4 on the other hand, wherein the machine foundation 4 is preferably part of a ship structure.

The shock is thus absorbed both within the centrifuge by the spring-loaded drive spindle 31 and in the machine feet 22 under the machine frame 4. The rotating system—i.e. the centrifuge drum 11, the drive spindle 31 and the bearings 32, 33—thus forms a first spring-loaded mass, which is inserted into a second spring-loaded mass, specifically the entire centrifuge 1. As a result, the machine feet 22, which are designed as flexible dampers, no longer have to take over the suspension of the entire vibrating system. The spring travel of the machine feet 22 under the machine frame 4 can also be significantly reduced, so that undesirable rocking movements of the separator, caused for example by rough seas, are significantly reduced.

In order to further optimize the damping properties of the entire vibration-capable system, a spring-loaded decoupling of the drive motor 35 from the machine frame 2 would also be conceivable, which would lead to a further damping option and thus to a distribution of the shock energy acting on the centrifuge 1.

List of reference signs

| | |
|---|---|
| 1 | Centrifuge |
| 11 | Centrifuge drum |
| 111 | Distributor |
| 112 | Product feed pipe |
| 113 | Separation chamber |
| 114 | Disk stack |
| 115 | Solids collecting chamber |
| 12 | Hood |
| 13 | Liquid discharge |
| 121 | Upper hood section |
| 122 | Lower hood section |
| 123 | Path-limiting element |
| 124 | Interior |
| 2 | Machine frame |
| 21 | Lug |
| 22 | Machine foot |
| 221 | Spring elements |
| 222 | Plate |
| 223 | Plate |
| 224 | Ring |
| 225 | Sleeve |
| 226 | Screw |
| 23 | Support |
| 3 | Drive unit |
| 31 | Drive spindle |
| 311 | Shoulder |
| 312 | Shoulder |
| 32 | Neck bearing |
| 321 | Inner ring |
| 322 | Outer ring |
| 323 | Housing |
| 324 | Shoulder |
| 33 | Foot bearing |
| 331 | Inner ring |
| 332 | Outer ring |
| 333 | Sleeve |
| 3331 | Collar |
| 334 | Spring |
| 335 | Disk |
| 3351 | Centering lug |
| 336 | Inner sleeve |
| 337 | Ball joint |
| 338 | Outer sleeve |
| 339 | Bearing cup |
| 34 | Wrap-around gear |
| 341 | Belt pulley |
| 342 | Belt pulley |
| 35 | Drive motor |
| 351 | Drive shaft |
| 36 | Bearing support |
| 4 | Machine foundation |
| D | Axis of rotation |
| P | Product |
| L | Liquid phase |
| S | Solid phase |

1-24. (canceled)

25. A centrifuge comprising:
a centrifuge drum with a vertical axis of rotation, wherein a disk stack is arranged in the centrifuge drum;
a drive spindle of the centrifuge drum rotatably mounted in or on a machine frame by a neck bearing and a foot bearing, wherein the neck bearing is axially displaceable and radially supported, and wherein the drive spindle is axially deflectable;
a drive motor coupled to and configured to drive the drive spindle; and
a spring arranged centrally under the foot bearing of the drive spindle, wherein the spring supports a unit consisting of the centrifuge drum, the drive spindle, the neck bearing, and the foot bearing in an axially limited deflectable resilient manner with respect to the machine frame,
wherein the foot bearing includes an outer ring,
wherein the outer ring of the foot bearing is mounted in a sleeve arranged on the spring,
wherein the centrifuge is a separator configured to separate, in a centrifugal field, a product to be processed into a solid phase and into at least one liquid phase, and
wherein the centrifuge is designed for use on a ship.

26. The centrifuge of claim 25, wherein the neck bearing has an inner ring and an outer ring, and wherein the neck bearing is axially displaceably guided via the inner ring of the neck bearing and is radially resiliently supported via the outer ring of the neck bearing.

27. The centrifuge of claim 25, wherein the foot bearing is supported radially in the sleeve by the outer ring of the foot bearing.

28. The centrifuge of claim 25, wherein the sleeve is inserted in an axially displaceable manner into a bore of an inner sleeve of a ball joint.

29. The centrifuge of claim 25, wherein an upper axial side the sleeve has a collar projecting radially outwards, wherein the collar is configured to limit an axial movement of the sleeve downwards.

30. The centrifuge of claim 25, wherein a maximum possible path of the sleeve during a downward movement is dimensioned such that the spring is not compressed to a block during the downward movement.

31. The centrifuge of claim 25, wherein the spring is a helical spring or has one or more disk spring(s).

32. The centrifuge of claim 25, wherein the spring is supported on a disk having a centering lug for the spring.

33. The centrifuge of claim 32, wherein the sleeve is configured in such a way that when the sleeve moves downwards to a maximum possible extent, the centering lug of the spring on the disk dips into the sleeve.

34. The centrifuge of claim 32, wherein the disk is axially attached to a lower side of a bearing cup, wherein the bearing cup is inserted in a tubular lug, and wherein the tubular lug is inserted into a lower opening of a machine frame of the centrifuge.

35. The centrifuge of claim 25, wherein the drive motor is coupled to the drive spindle via a belt transmission.

36. The centrifuge of claim 25, wherein the machine frame is connected to a machine foundation via a plurality of machine feet, wherein the machine feet are flexible dampers or shock absorbers.

37. The centrifuge of claim 36, wherein the machine feet are rubber-metal parts.

38. The centrifuge of claim 34, wherein the foot bearing is arranged so that the foot bearing is inclinable an articulated-cardanic manner relative to the machine frame by a ball joint.

39. The centrifuge of claim 38, wherein an outer sleeve of the ball joint is inserted into the bearing cup.

40. The centrifuge of claim 25, further comprising:
a hood configured so that the hood is stationary during operation of the centrifuge, wherein the hood surrounds the centrifuge drum and is arranged on and supported on the machine frame.

41. The centrifuge of claim 40, further comprising:
a plurality of path-limiting elements mounted in an interior of the hood below and above the centrifuge drum and circumferentially distributed around the centrifuge drum.

42. The centrifuge of claim 41, wherein the path-limiting elements are a ring or a ring segment.

43. The centrifuge of claim 41, wherein the path-limiting elements is made of a non-ferrous metal.

44. The centrifuge of claim 38, further comprising:
an elastic housing having a shoulder, wherein the shoulder of the elastic housing is inserted into a bearing support through which the drive spindle engages.

45. The centrifuge of claim 44, wherein the bearing support with the elastic housing and the neck bearing is inserted into the machine frame.

46. The centrifuge of claim 44, wherein the elastic housing is a rubber-metal part.

47. The centrifuge of claim 45, wherein the bearing support, the elastic housing, and the neck bearing form a pre-assembled and replaceable structural unit.

48. The centrifuge of claim 44, wherein the bearing support and the bearing cup are a one-piece bearing housing, wherein the drive spindle with the neck bearing and the elastic housing, the foot bearing, the sleeve, the spring, the ball joint, and the disk are insertable into the machine frame as a pre-assembled unit.
